(19) United States
(12) Patent Application Publication
(10) Pub. No.: US 2016/0255353 A1
(43) Pub. Date: Sep. 1, 2016

(54) HIGHEST TEMPORAL SUB-LAYER LIST

(71) Applicant: SHARP KABUSHIKI KAISHA, Osaka (JP)

(72) Inventor: Sachin G. DESHPANDE, Camas, WA (US)

(21) Appl. No.: 15/027,288

(22) PCT Filed: Oct. 10, 2014
(86) PCT No.: PCT/JP2014/005179

§ 371 Date: Apr. 5, 2016

Related U.S. Application Data
(60) Provisional application No. 61/953,633, filed on Mar. 14, 2014.
(60) Provisional application No. 61/890,020, filed on Oct. 11, 2013.

(51) Int. Cl. H04N 19/187; H04N 19/46; H04N 19/136; H04N 19/196; H04N 19/61; H04N 19/169

(52) U.S. Cl. CPC H04N 19/187; H04N 19/61; H04N 19/188; H04N 19/136; H04N 19/196; H04N 19/46; H04N 19/105

(57) ABSTRACT

A method for video coding is described. In one configuration, the maximum number of temporal sub-layers that may be present in each layer in the bitstream is signaled in the bitstream. The signaled information may be used to derive the values of the highest temporal identifier for each layer.

### CROSS-REFERENCE TO RELATED APPLICATIONS

None.

### TECHNICAL FIELD

The present disclosure relates generally to electronic devices. More specifically, the present disclosure relates to systems and methods for decoding the highest temporal sub-layer.

### BACKGROUND ART

Electronic devices have become smaller and more powerful in order to meet consumer needs and to improve portability and convenience. Consumers have become dependent upon electronic devices and have come to expect increased functionality. Some examples of electronic devices include desktop computers, laptop computers, cellular phones, smart phones, media players, integrated circuits, etc.

Some electronic devices are used for processing and displaying digital media. For example, portable electronic devices now allow for digital media to be consumed at almost any location where a consumer may be. Furthermore, some electronic devices may provide downloading or streaming of digital media content for the use and enjoyment of a consumer.

The increasing popularity of digital media has presented several problems. For example, efficiently representing high-quality digital media for storage, transmittal and playback presents several challenges. As can be observed from this discussion, systems and methods that represent digital media more efficiently may be beneficial.

### SUMMARY OF INVENTION

One embodiment of the present invention discloses a method for video coding, comprising: signaling an information of a number of layers in a bitstream; and indicating a maximum number of temporal sub-layers that may be present for each layer in the bitstream.

Another embodiment of the present invention discloses an electronic device configured for video coding, comprising: a processor; memory in electronic communication with the processor, wherein instructions stored in the memory are executable to: signal an information of a number of layers in a bitstream; and indicate a maximum number of temporal sub-layers that may be present for each layer in the bitstream.

Yet another embodiment of the present invention discloses a method for video decoding, comprising: decoding an information of a number of layers in a bitstream; and deriving a maximum number of temporal sub-layers that may be present for each layer in the bitstream.

Yet another embodiment of the present invention discloses an electronic device configured for video decoding, comprising: a processor; memory in electronic communication with the processor, wherein instructions stored in the memory are executable to: decode an information of a number of layers in a bitstream; and derive a maximum number of temporal sub-layers that may be present for each layer in the bitstream.

Yet another embodiment of the present invention discloses a method for video coding, comprising: obtaining a bitstream that comprises coded pictures for one or more layers; and selecting a target highest temporal identifier value (HighestTid), wherein the target highest temporal identifier value (HighestTid) is in the range of zero to a maximum number of temporal sub-layers that may be present in the layer set minus one.

Yet another embodiment of the present invention discloses an electronic device configured for video coding, comprising: a processor; memory in electronic communication with the processor, wherein instructions stored in the memory are executable to: obtain a bitstream that comprises coded pictures for one or more layers; and select a target highest temporal identifier value (HighestTid), wherein the target highest temporal identifier value (HighestTid) is in the range of zero to a maximum number of temporal sub-layers that may be present in the layer set minus one.

Yet another embodiment of the present invention discloses a method for video decoding, comprising: receiving a bitstream that comprises coded pictures for one or more layers; and decoding a target highest temporal identifier value (HighestTid), wherein the target highest temporal identifier value (HighestTid) is in the range of zero to a maximum number of temporal sub-layers that may be present in the layer set minus one.

Yet another embodiment of the present invention discloses an electronic device configured for video decoding, comprising: a processor; memory in electronic communication with the processor, wherein instructions stored in the memory are executable to: receive a bitstream that comprises coded pictures for one or more layers; and decode a target highest temporal identifier value (HighestTid), wherein the target highest temporal identifier value (HighestTid) is in the range of zero to a maximum number of temporal sub-layers that may be present in the layer set minus one.

### BRIEF DESCRIPTION OF DRAWINGS

FIG. 1 is a block diagram illustrating video coding between multiple electronic devices.

FIG. 2 is a flow diagram of a method for deriving the highest temporal identifier (TemporalId) values per layer.

FIG. 3 is a flow diagram of another method for deriving a highest temporal identifier (TemporalId) value per layer.

FIG. 4 is a flow diagram of yet another method for deriving a highest temporal identifier (TemporalId) value per layer.

FIG. 5 is a block diagram illustrating one configuration of a decoder.

FIG. 6 is a block diagram illustrating one configuration of a video encoder on an electronic device.

FIG. 7 is a block diagram illustrating one configuration of a video decoder on an electronic device.

FIG. 8 is a block diagram illustrating various components that may be utilized in a transmitting electronic device.

FIG. 9 is a block diagram illustrating various components that may be utilized in a receiving electronic device.

### DESCRIPTION OF EMBODIMENTS

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

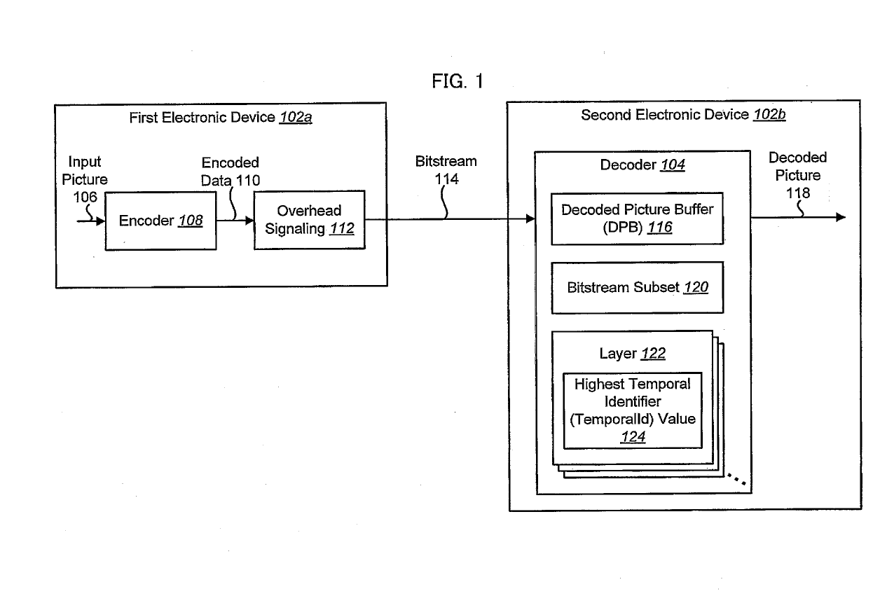

FIG. 1 is a block diagram illustrating video coding between multiple electronic devices 102a-b. A first electronic device 102a and a second electronic device 102b are illustrated. However, it should be noted that one or more of the features and functionality described in relation to the first electronic device 102a and the second electronic device 102b may be combined into a single electronic device 102 in some configurations. Each electronic device 102 may be configured to encode video and/or decode video.

As used herein, access unit (AU) refers to a set of network abstraction layer (NAL) units that are associated with each other according to a specified classification rule, that are consecutive in decoding order, and that include the video coding layer (VCL) NAL units of all coded pictures associated with the same output time and their associated non-VCL NAL units. The base layer is a layer in which all VCL NAL units have a nuh_layer_id equal to 0. A coded picture is a coded representation of a picture that includes VCL NAL units with a particular value of nuh_layer_id and that includes all the coding tree units of the picture. In some cases a coded picture may be called a layer component.

In one configuration, each of the electronic devices 102 may conform to the High Efficiency Video Coding (HEVC) standard, the Scalable High Efficiency Video Coding (SHVC) standard or the Multi-view High Efficiency Video Coding (MV-HEVC) standard. The HEVC standard is a video compression standard that acts as a successor to H.264/MPEG-4 AVC (Advanced Video Coding) and that provides improved video quality and increased data compression ratios. As used herein, a picture is an array of luma samples in monochrome format or an array of luma samples and two corresponding arrays of chroma samples in 4:2:0, 4:2:2 and 4:4:4 colour format or some other colour format. The operation of a hypothetical reference decoder (HRD) and the operation of the output order decoded picture buffer (DPB) 116 are described for SHVC and MV-HEVC in JCTVC-N1008, JCTVC-M1008, JCTVC-L1008, JCT3V-E1004, JCT3V-D1004, JCT3V-C1004, JCTVC-L0453 and JCTVC-L0452. HEVC operation is defined in JCTVC-L1003.

Additional descriptions are described in B. Bros, W-J. Han, J-R. Ohm, G. J. Sullivan, and T. Wiegand, “High efficiency video coding (hevc) text specification draft 10, “jctvc-11003, geneva, January 2013; G. Tech, K. Wegner, Y. Chen, M. Hannuksela, J. Boyce, “MV-HEVC draft text 7” JCT3V-G1004, San Jose, January 2014; J. Chen, J. Boyce, Y. Ye, M. M. Hannuksela, “High efficiency video coding (hevc) scalable extension draft 5”, JCTVC-P1008, San Jose, January 2014 each of which is incorporated by reference herein in its entirety.

The first electronic device 102a may include an encoder 108 and an overhead signaling module 112. The first electronic device 102a may obtain an input picture 106. In some configurations, the input picture 106 may be captured on the first electronic device 102a using an image sensor, retrieved from memory and/or received from another electronic device 102. The encoder 108 may encode the input picture 106 to produce encoded data 110. For example, the encoder 108 may encode a series of input pictures 106 (e.g., video). The encoded data 110 may be digital data (e.g., a bitstream).

The overhead signaling module 112 may generate overhead signaling based on the encoded data 110. For example, the overhead signaling module 112 may add overhead data to the encoded data 110 such as slice header information, video parameter set (VPS) information, sequence parameter set (SPS) information, picture parameter set (PPS) information, picture order count (POC), reference picture designation, etc. In some configurations, the overhead signaling module 112 may produce a wrap indicator that indicates a transition between two sets of pictures.

The encoder 108 (and overhead signaling module 112, for example) may produce a bitstream 114. The bitstream 114 may include encoded picture data based on the input picture 106. In some configurations, the bitstream 114 may also include overhead data, such as slice header information, VPS information, SPS information, PPS information, etc. As additional input pictures 106 are encoded, the bitstream 114 may include one or more encoded pictures. For instance, the bitstream 114 may include one or more encoded reference pictures and/or other pictures.

The bitstream 114 may be provided to a decoder 104. In one example, the bitstream 114 may be transmitted to the second electronic device 102b using a wired or wireless link In some cases, this may be done over a network, such as the Internet or a Local Area Network (LAN). As illustrated in FIG. 1, the decoder 104 may be implemented on the second electronic device 102b separately from the encoder 108 on the first electronic device 102a. However, it should be noted that the encoder 108 and decoder 104 may be implemented on the same electronic device 102 in some configurations. When the encoder 108 and decoder 104 are implemented on the same electronic device 102, for instance, the bitstream 114 may be provided over a bus to the decoder 104 or stored in memory for retrieval by the decoder 104.

The decoder 104 may receive (e.g., obtain) the bitstream 114. The decoder 104 may generate a decoded picture 118 (e.g., one or more decoded pictures 118) based on the bitstream 114. The decoded picture 118 may be displayed, played back, stored in memory and/or transmitted to another device, etc.

The decoder 104 may include a decoded picture buffer (DPB) 116. The decoded picture buffer (DPB) 116 may be a buffer holding decoded pictures for reference, output reordering or output delay specified for a hypothetical reference decoder (HRD). On an electronic device 102, a decoded picture buffer (DPB) 116 may be used to store reconstructed (e.g., decoded) pictures at a decoder 104. These stored pictures may then be used, for example, in an inter-prediction mechanism. When pictures are decoded out of order, the pictures may be stored in the decoded picture buffer (DPB) 116 so they can be displayed later in order.

JCTVC-N1008 and JCT3V-E1004 describe the decoding of the variable HighestTid. The variable HighestTid identifies the highest temporal sub-layer to be decoded. For decoding the variable HighestTid, it is specified that if some external means (which is not specified in the cited Specifications) is available to set the variable HighestTid, then the variable HighestTid is set by the external means. If no external means are available, but if the decoding process is invoked in a bitstream conformance test (as specified in subclause C.1 of JCTVC-L1003), then the variable HighestTid is set as specified in subclause C.1. Otherwise, the variable HighestTid may be set equal to the parameter sps_max_sub_layers_minus1, which specifies one less than the maximum number of temporal sub-layers that may be present in each coded video sequence (CVS) referring to the SPS.

The language of Annex C, subclause C.1 of JCTVC-L1003 is given below in Listing (1):
1. An operation point under test, denoted as TargetOp, is selected. The layer identifier list OpLayerIdList of TargetOp consists of the list of nuh_layer_id values, in increasing order of nuh_layer_id values, present in the bitstream subset associated with TargetOp, which is a subset of the nuh_layer_id values present in the bitstream under test. The OpTid of TargetOp is equal to the highest TemporalId present in the bitstream subset associated with TargetOp.
2. TargetDecLayerIdList is set equal to OpLayerIdList of TargetOp, HighestTid is set equal to OpTid of TargetOp, and the sub-bitstream extraction process as specified in clause 10 is invoked with the bitstream under test, HighestTid, and TargetDecLayerIdList as inputs, and the output is assigned to BitstreamToDecode.

### Listing (1)

The variable HighestTid that is decoded in JCTVC-N1008 and JCT3V-E1004 may be used during HRD operation and also for the marking process for sub-layer non-reference pictures that are not needed for inter-layer prediction. In particular, during the decoding process for ending the decoding of a coded picture with nuh_layer_id >0 (as specified in Section F.8.1.2 of JCTVC-N1008). When the temporal identifier TemporalId is equal to the variable HighestTid, the marking process for sub-layer non-reference pictures not needed for inter-layer prediction (specified in Section F.8.1.2.1 of JCTVC-N1008) is invoked with latestDecLayerId equal to nuh_layer_id as input.

It is asserted that in SHVC, different layers 122 may have different frame rates. As a result, a layer 122 with a higher frame rate may have a higher value of highest temporal sub-layer compared to a layer 122 with a lower frame-rate. In this case, using the current decoding process, the HighestTid value will be set equal to the highest temporal sub-layer in the bitstream 114 (when using subclause C.1 of Annex C to set the HighestTid value). The marking process for sub-layer non-reference pictures not needed for inter-layer prediction (in Section F.8.1.2.1) may not be invoked for layers 122 that have lower frame rates, since the highest temporal identifier TemporalId value in those layers 122 is less than the HighestTid value for the bitstream 114. Hence, sub-layer non-reference pictures in the highest temporal sub-layer of such layers 122 may not be removed earlier and the potential decoded picture buffer (DPB) 116 memory saving may not be achieved. Changes to the decoding process described herein may help achieve these decoded picture buffer (DPB) 116 memory savings.

The decoder 104 may derive the highest temporal identifier (TemporalId) values 124 per layer 122 for a bitstream subset 120. In one configuration, the decoder 104 may derive the highest temporal identifier (TemporalId) values 124 per layer 122 using a general decoding process. In another configuration, the decoder 104 may derive the highest temporal identifier (TemporalId) values 124 per layer 122 during the derivation of bitstream conformance test. Furthermore, the marking process for sub-layer non-reference pictures not needed for inter-layer prediction (specified in subclause F.8.1.2.1) may be invoked when the temporal identifier (TemporalId) is equal to HighestTemporalIdList[nuh_layer_id] during the decoding process for ending the decoding of a coded picture with nuh_layer_id >0 (as specified in Section F.8.1.2), where HighestTemporalIdList is a list of values of the highest temporal identifier (TemporalId) present in the subset associated with TargetOp in order for each of the layers in the TargetDecLayerIdList.

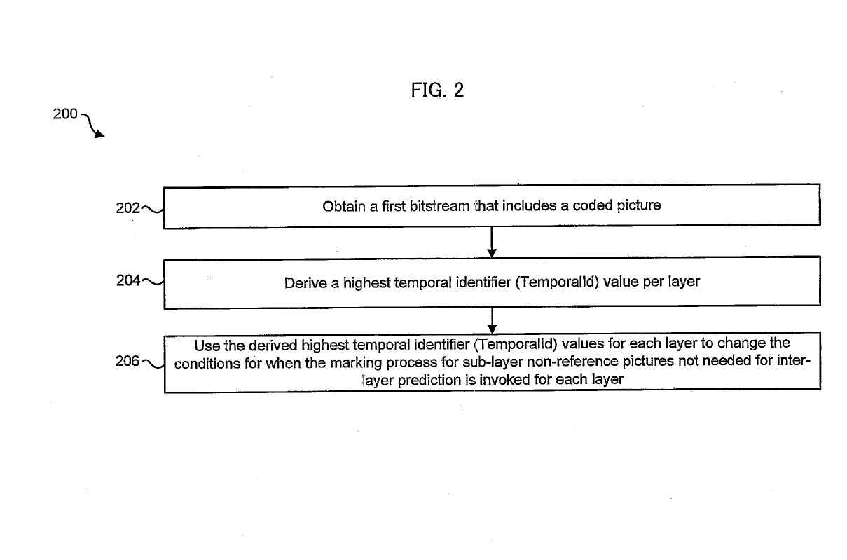

FIG. 2 is a flow diagram of a method 200 for deriving the highest temporal identifier (TemporalId) values 124 per layer 122. The method 200 may be performed by an electronic device 102. For example, the method 200 may be performed by a decoder 104 on the electronic device 102. The electronic device 102 may obtain 202 a bitstream 114 that includes a coded picture. As described above, the bitstream 114 may be received from another electronic device 102 (e.g., the first electronic device 102a ). The electronic device 102 may derive 204 a highest temporal identifier (TemporalId) value 124 per layer 122 based on the coded pictures of each layer. Each coded picture includes NAL units. Each NAL unit includes the variable nuh_temporal_id_plus1, which is used to calculate the temporal identifier (TemporalId) for that NAL unit. There may also be VCL and non-VCL NAL units. The semantics of nuh_temporal_id_plus1 in JCTVC-L1003 explains how the temporal identifier (TemporalId) is calculated.

The electronic device 102 may use 206 the derived highest temporal identifier (TemporalId) values 124 per layer 122 to change the condition for when the marking process for sub-layer non-reference pictures not needed for inter-layer prediction is invoked per layer 122 (as described in Section F.8.1.2.1). There is a decoding process for ending the decoding of a coded picture with nuh_layer_id>0. This process may do some bookkeeping functions, such as setting some flags (such as the PicOutputFlag) and marking a decoded picture 118. During this process, the marking process for sub-layer non-reference pictures not needed for inter-layer prediction may be invoked (as defined in Section F.8.1.2.1) if certain conditions are met. If the marking process is invoked, a picture may be marked or tagged based on a set of conditions. The term sub-layer refers to the temporal sub-layer. The term non-reference refers to NAL units that have the variable nal_unit_type ending in_N in the Table 7.1—NAL unit type codes and NAL unit type classes in JCTVC-L1003, which is not used as reference within the temporal sub-layer. The term inter-layer prediction refers to using a picture from one layer 122 (with nuh_layer_idnuhLayerIdA) as a reference picture for a picture from another layer 122 (with nuh_layer_idnuhLayerIdB). One example of a condition for determining whether a picture is marked/tagged is if the temporal identifier (TemporalId) is equal to HighestTemporalIdList[nuh_layer_id].

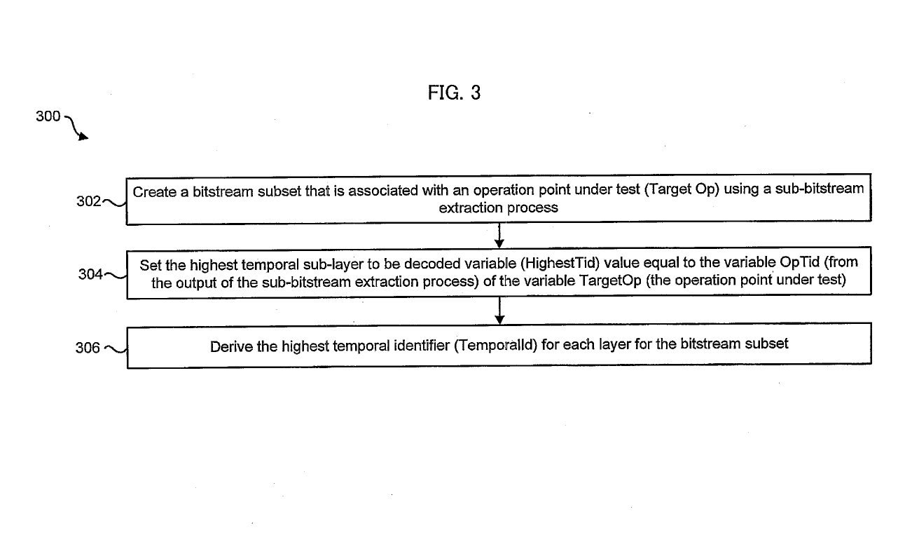

FIG. 3 is a flow diagram of another method 300 for deriving a highest temporal identifier (TemporalId) value 124 per layer 122. The method 300 may be performed by an electronic device 102. In one configuration, the method 300 may be performed by a decoder 104 on the electronic device 102. The electronic device 102 may create 302 a bitstream subset 120 that is associated with an operation point under test (TargetOp) using a sub-bitstream extraction process as specified in clause 10 of JCTVC-L1003. In the sub-bitstream extraction process, the electronic device 102 may set 304 the highest temporal sub-layer-to-be-decoded variable (HighestTid) value equal to the variable OpTid (from the output of the sub-bitstream extraction process) of the variable TargetOp (the operation point under test). The electronic device 102 may then derive 306 the highest temporal identifier (TemporalId) value 124 for each layer 122 for the bitstream subset 120 (which was based on the layer list and the variable HighestTid).

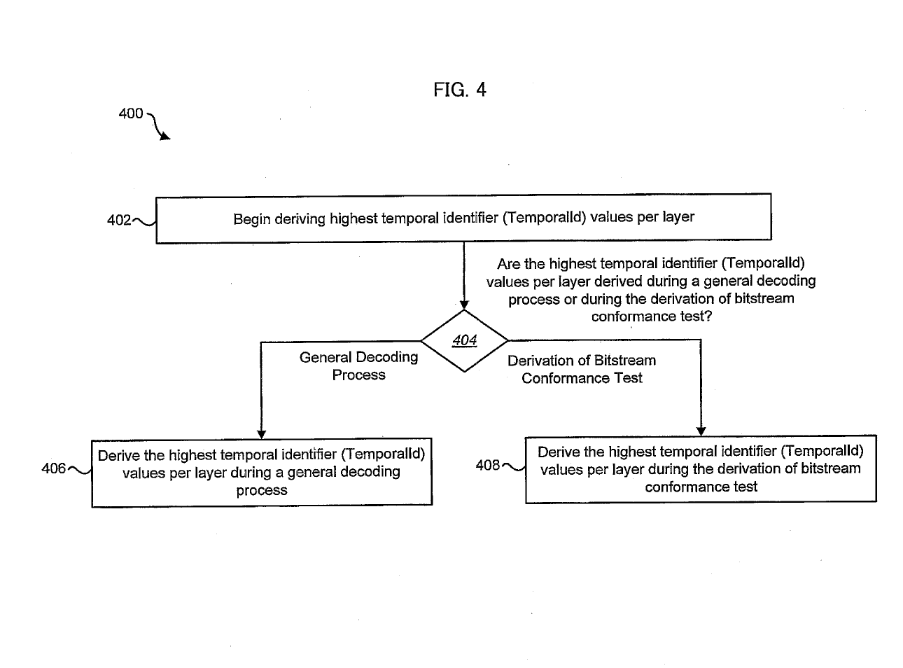

FIG. 4 is a flow diagram of yet another method 400 for deriving a highest temporal identifier (TemporalId) value 124 per layer 122. The method 400 may be performed by an electronic device 102. In one configuration, the method 400 may be performed by a decoder 104 on the electronic device 102. The electronic device 102 may begin 402 deriving a highest temporal identifier (TemporalId) value 124 per layer 122. The electronic device 102 may determine 404 whether the highest temporal identifier (TemporalId) values 124 per layer 122 are derived using a general decoding process or during the derivation of bitstream conformance test.

If a general decoding process is selected to derive the highest temporal identifier (TemporalId) values 124 per layer 122, then the electronic device 102 may derive 406 the highest temporal identifier (TemporalId) values 124 per layer 122 during a general decoding process. An example of the language for JCTVC_N1008 for deriving 406 the highest temporal identifier (TemporalId) values 124 per layer 122 is given below in Listing (2):

8 Decoding Process

8.1 General Decoding Process

Input to this process is a bitstream. Output of this process is a list of decoded pictures. The layer identifier list TargetDecLayerIdList, which specifies the list of nuh_layer_id values, in increasing order of nuh_layer_id values, of the NAL units to be decoded, is specified as follows:
If some external means, not specified in this Specification, is available to set TargetDecLayerIdList, TargetDecLayerIdList is set by the external means.
Otherwise, if the decoding process is invoked in a bitstream conformance test as specified in subclause C.1, TargetDecLayerIdList is set as specified in subclause C.1.
Otherwise, TargetDecLayerIdList contains only one nuh_layer_id value that is equal to 0.

The variable HighestTid, which identifies the highest temporal sub-layer to be decoded, is specified as follows:
If some external means, not specified in this Specification, is available to set HighestTid, HighestTid is set by the external means.
Otherwise, if the decoding process is invoked in a bitstream conformance test as specified in subclause C.1, HighestTid is set as specified in subclause C.1.
Otherwise, HighestTid is set equal to sps_max_sub_layers_minus1.

The temporal sub-layer identifier list HighestTemporalIdList, which specifies the list of values of highest TemporalId present in the bitstream subset associated with TargetOp in order for each of the layer in the TargetDecLayerIdList, is specified as follows:

Variant 1a:

for( i=0; i < number of layers in TargetDecLayerIdList;i++) {

HighestTemporalIdList[ i ] = Highest TemporalId value in the
bitstream

subset associated with TargetOp for the layer with nuh_layer_id equal to
TargetDecLayerIdList[ i ];
}

Variant 1b:

The variable OutputLayerSetIdx, which specifies the index to the list of the output layer sets specified by the VPS, of the target output layer set, is specified as follows:
If some external means, not specified in this Specification, is available to set OutputLayerSetIdx, OutputLayerSetIdx is set by the external means.
Otherwise, if the decoding process is invoked in a bitstream conformance test as specified in subclause C.1, OutputLayerSetIdx is set as specified in subclause C.1.
Otherwise, OutputLayerSetIdx is set equal to 0.

lsetIdx = output_layer_set_idx_minus1[ OutputLayerSetIdx ] + 1;
for( i=0; i < numLayersInIdList[ lsetIdx ];i++) {

HighestTemporalIdList[ i ] = Highest TemporalId value in the
bitstream

subset associated with TargetOp for the layer with nuh_layer_id equal to
TargetDecLayerIdList[ i ];
}

The sub-bitstream extraction process as specified in clause 10 is applied with the bitstream, HighestTid, and TargetDecLayerIdList as inputs, and the output is assigned to a bitstream referred to as BitstreamToDecode.

The decoding processes specified in the remainder of this subclause apply to each coded picture, referred to as the current picture and denoted by the variable CurrPic, in BitstreamToDecode.

Depending on the value of chroma_format_idc, the number of sample arrays of the current picture is as follows:
If chroma_format_idc is equal to 0, the current picture consists of 1 sample array SL.
Otherwise (chroma_format_idc is not equal to 0), the current picture consists of 3 sample arrays SL, SCb, SCr.

The decoding process for the current picture takes as inputs the syntax elements and upper-case variables from clause 7. When interpreting the semantics of each syntax element in each NAL unit, the term “the bitstream” (or part thereof, e.g. a CVS of the bitstream) refers to BitstreamToDecode (or part thereof).

### Listing (2)

In variant la of Listing (2), the temporal sub-layer identifier list HighestTemporalIdList specifies the list of values of the highest temporal identifier (TemporalId) present in the bitstream subset 120. Variant 1b of Listing (2) is more specific than variant 1a. For example, variant 1b defines how the OutputLayerSetIdx is calculated and then how 1SetIdx is calculated based on OutputLayerSetIdx and output_layer_set_idex_minus1. Variant 1b also uses numLayersInIdList[1SetIdx] in the for loop.

The electronic device 102 may derive 408 the highest temporal identifier (TemporalId) values 124 per layer 122 during the derivation of bitstream conformance test (referred to as variant 2). An example of the language for JCTVC-L1003 for deriving 408 the highest temporal identifier (TemporalId) values 124 per layer 122 during the derivation of bitstream conformance test is given below in Listing (3):

F.8 General

This annex specifies the hypothetical reference decoder (HRD) and its use to check bitstream and decoder conformance.

Two types of bitstreams or bitstream subsets are subject to HRD conformance checking for this Specification. The first type, called a Type I bitstream, is a NAL unit stream containing only the VCL NAL units and NAL units with nal_unit_type equal to FD_NUT (filler data NAL units) for all access units in the bitstream. The second type, called a Type II bitstream, contains, in addition to the VCL NAL units and filler data NAL units for all access units in the bitstream, at least one of the following:
additional non-VCL NAL units other than filler data NAL units,
all leading_zero_8 bits, zero_byte, start_code_prefix_one_3 bytes, and trailing_zero_8 bits syntax elements that form a byte stream from the NAL unit stream (as specified in Annex B).

Figure C-1 shows the types of bitstream conformance points checked by the HRD.

Figure C-1—Structure of byte streams and NAL unit streams for HRD conformance checks

The syntax elements of non-VCL NAL units (or their default values for some of the syntax elements), required for the HRD, are specified in the semantic subclauses of clause 7, Annexes D and E.

Two types of HRD parameter sets (NAL HRD parameters and VCL HRD parameters) are used. The HRD parameter sets are signalled through the hrd_parameters( ) syntax structure, which may be part of the SPS syntax structure or the VPS syntax structure. Multiple tests may be needed for checking the conformance of a bitstream, which is referred to as the bitstream under test. For each test, the following steps apply in the order listed:
1. An operation point under test, denoted as TargetOp, is selected. The layer identifier list OpLayerIdList of TargetOp consists of the list of nuh_layer_id values, in increasing order of nuh_layer_id values, present in the bitstream subset associated with TargetOp, which is a subset of the nuh_layer_id values present in the bitstream under test. The OpTid of TargetOp is equal to the highest TemporalId present in the bitstream subset associated with TargetOp.
2. TargetDecLayerIdList is set equal to OpLayerIdList of TargetOp, HighestTid is set equal to OpTid of TargetOp, and the sub-bitstream extraction process as specified in clause 10 is invoked with the bitstream under test, HighestTid, and TargetDecLayerIdList as inputs, and the output is assigned to BitstreamToDecode.
3. HighestTemporalIdList consists of list of values of highest TemporalId present in the bitstream subset associated with TargetOp in order for each of the layer in the TargetDecLayerIdList.
4. The hrd_parameters( ) syntax structure and the sublayer_hrd_parameters( ) syntax structure applicable to TargetOp are selected. If TargetDecLayerIdList contains all nuh_layer_id values present in the bitstream under test, the hrd_parameters( ) syntax structure in the active SPS (or provided through an external means not specified in this Specification) is selected. Otherwise, the hrd_parameters( ) syntax structure in the active VPS (or provided through some external means not specified in this Specification) that applies to TargetOp is selected. Within the selected hrd_parameters( ) syntax structure, if BitstreamToDecode is a Type I bitstream, the sub_layer_hrd_parameters(HighestTid) syntax structure that immediately follows the condition “if(vcl_hrd_parameters_present_flag)” is selected and the variable NalHrdModeFlag is set equal to 0; otherwise (BitstreamToDecode is a Type II bitstream), the sub_layer_hrd_parameters(HighestTid) syntax structure that immediately follows either the condition “if(vcl_hrd_parameters_present_flag)” (in this case the variable NalHrdModeFlag is set equal to 0) or the condition “if(nal_hrd_parameters_present_flag)” (in this case the variable NalHrdModeFlag is set equal to 1) is selected. When BitstreamToDecode is a Type II bitstream and NalHrdModeFlag is equal to 0, all non-VCL NAL units except filler data NAL units, and all leading_zero_8 bits, zero byte, start_code_prefix_one_3 bytes, and trailing_zero_8 bits syntax elements that form a byte stream from the NAL unit stream (as specified in Annex B), when present, are discarded from BitstreamToDecode, and the remaining bitstream is assigned to BitstreamToDecode.

### Listing (3)

In one configuration, the maximum number of temporal sub-layers that may be present in each layer in the bitstream 114 may be signaled in the bitstream 114. In some cases, this information may be signaled as part of the overhead signaling 112. This signaled information regarding the maximum number of temporal sub-layers for a layer may then be used to derive the values of the highest temporal identifier (TemporalId) for each layer (i.e. for the derivation of HighestTemporalIdList[i]).

The information regarding the maximum number of temporal sub-layers that may be present in each layer may be signaled as shown below in Table 1A. In Table 1A, the sub_layers_vps_max_minus1 are signaled in the video parameter set (VPS). However, in general this information could be signaled in other parameter sets, such as the sequence parameter set (SPS), the picture parameter set (PPS) and/or in the slice segment header and/or in any other normative part of the bitstream. Table 1A comes from F.7.3.2.1.1 Video parameter set extension syntax of JCTVC-N1008.

TABLE 1A

| vps_extension( ) { | Descriptor |
|---|---|
| avc_base_layer_flag | u(1) |
| vps_vui_offset | u(16) |
| .... | |
| for( i = 1; i <= vps_max_layers_minus1; i++ ) | |
| for( j = 0; j < i; j++ ) | |
| direct_dependency_flag[ i ][ j ] | u(1) |
| for( i = 0; i <= vps_max_layers_minus1; i++ ) | |
| sub_layers_vps_max_minus1[ i ] | u(3) |
| ... | |
| } | |

In an alternative embodiment, the information regarding the maximum number of temporal sub-layers that may be present in each layer may be signaled as shown below in Table 1B. In Table 1B, the sub_layers_vps_max_minus1 are signaled in the video parameter set (VPS). However, in general this information could be signaled in other parameter sets, such as the sequence parameter set (SPS), the picture parameter set (PPS) and/or in the slice segment header and/or in any other normative part of the bitstream.

TABLE 1B

| vps_extension( ) { | Descriptor |
|---|---|
| avc_base_layer_flag | u(1) |
| vps_vui_offset | u(16) |
| .... | |
| for( i = 1; i <= vps_max_layers_minus1; i++ ) | |
| for( j = 0; j < i; j++ ) | |
| direct_dependency_flag[ i ][ j ] | u(1) |
| vps_sub_layers_max_minus1_present_flag | u(1) |
| if( vps_sub_layers_max_minus1_present_flag ) | |
| for( i = 0; i <= MaxLayersMinus1; i++ ) | |
| sub_layers_vps_max_minus1[ i ] | u(3) |
| ... | |
| } | |

In both embodiments, the variable sub_layers_vps_max_minus1[i]_plus_1 specifies the maximum number of temporal sub-layers that may be present in the CVS for the layer with nuh_layer_id equal to layer_id_in_nuh[i]. The value of sub_layers_vps_max_minus1[i] shall be in the range of 0 to vps_max_sub_layers_minus1 inclusive. When not present, sub_layers_vps_max_minus1[i] shall be equal to vps_max_sub_layers_minus1.

In some cases, the value of sub_layers_vps_max_minus1[i] shall be in the range of 0 to 6 inclusive. In some cases, sub_layers_vps_max_minus1[i] may not be signaled for the base layer and thus the signaling loop index (i) will start at 1 as follows:

for( i=1; I <= vps_max_layers_minus1; i++)

sub_layers_vps_max_minus1[ i ]

In some cases vps_sub_layers_max_minus1_present_flag equal to 1 specifies that the syntax elements sub_layers_vps_max_minus1[i] are present. vps_sub_layers_max_minus1_present_flag equal to 0 specifies that the syntax elements sub_layers_vps_max_minus1[i] are not present.

In another embodiment sub_layers_vps_max_minus1[i] plus 1 specifies the maximum number of temporal sub-layers that may be present in the CVS for the layer with nuh_layer_id equal to layer_id_in_nuh[i]. The value of sub_layers_vps_max_minus1[i] shall be in the range of 0 to vps_max_sub_layers_minus1, inclusive. When not present, sub_layers_vps_max_minus1[i] is inferred to be equal to vps_max_sub_layers_minus1.

In some cases vps_max_layers_minus1 plus 1 specifies the maximum allowed number of layers in the CVS. vps_max_layers_minus1 shall be less than 63 in bitstreams conforming to this version of this Specification. The value of 63 for vps_max_layers_minus1 may be reserved for future use by ITU-T1 ISO/IEC. Although the value of vps_max_layers_minus1 is required to be less than 63 in this version of this Specification, decoders shall allow a value of vps_max_layers_minus1 equal to 63 to appear in the syntax. It is anticipated that in a future super multiview coding extension of this specification, the value of 63 for vps_max_layers_minus1 will be used to indicate an extended number of layers.

The variable MaxLayersMinus1 may be set equal to Min(62, vps_max_layers_minus1).

JCTVC-N1008 defines that avc_base_layer_flag equal to 1 specifies that the base layer conforms to Rec. ITU-T H.265 I ISO/IEC 14496-10 and that avc_base_layer_flag equal to 0 specifies that the base layer conforms to this Specification. JCTVC-N1008 defines that vps_vui_offset specifies the byte offset, starting from the beginning of the VPS NAL unit, of the set of fixed-length coded information starting from bit_rate_present_vps_flag, when present, in the VPS NAL unit. When present, emulation prevention bytes that appear in the VPS NAL unit are counted for purposes of byte offset identification. The variable direct_dependency_flag[i][j] equal to 0 specifies that the layer with index j is not a direct reference layer for the layer with index i. The variable direct_dependency_flag[i][j] equal to 1 specifies that the layer with index j may be a direct reference layer for the layer with index i. When direct_dependency_flag[i][j] is not present for i and j in the range of 0 to vps_max_layers_minus1, it is inferred to be equal to 0.

The signaled information sub_layer_vps_max_minus1[i] may then be used to create two additional variants, similar to Listing (2) and Listing (3), which use the signaled information regarding the maximum number of temporal sub-layers for a layer to derive the values of highest TemporalId for each layer. An example of the language for JCTVC-N1008 for deriving 406 the highest temporal identifier (TemporalId) values 124 per layer 122 when using the signaling from Table 1A or Table 1B is given below in Listing (4):

8 Decoding Process

8.1 General Decoding Process

Input to this process is a bitstream. Output of this process is a list of decoded pictures. The layer identifier list TargetDecLayerIdList, which specifies the list of nuh_layer_id values, in increasing order of nuh_layer_id values, of the NAL units to be decoded, is specified as follows:
If some external means, not specified in this Specification, is available to set TargetDecLayerIdList, TargetDecLayerIdList is set by the external means.
Otherwise, if the decoding process is invoked in a bitstream conformance test as specified in subclause C.1, TargetDecLayerIdList is set as specified in subclause C.1.
Otherwise, TargetDecLayerIdList contains only one nuh_layer_id value that is equal to 0.

The variable HighestTid, which identifies the highest temporal sub-layer to be decoded, is specified as follows:
If some external means, not specified in this Specification, is available to set HighestTid, HighestTid is set by the external means.
Otherwise, if the decoding process is invoked in a bitstream conformance test as specified in subclause C.1, HighestTid is set as specified in subclause C.1.
Otherwise, HighestTid is set equal to sps_max_sub_layers_minus1.

The temporal sub-layer identifier list HighestTemporalIdList, which specifies the list of values of highest TemporalId present in the bitstream subset associated with TargetOp in order for each of the layer in the TargetDecLayerIdList, is specified as follows: Variant 3a:

for( i=0; i < number of layers in TargetDecLayerIdList;i++) {

HighestTemporalIdList[ i ] = Min(HighestTid,

sub_layers_vps_max_minus1[ LayerIdxInVps[ TargetDecLayerIdList[ i ]]);
}

Variant 3b:

The variable OutputLayerSetIdx, which specifies the index to the list of the output layer sets specified by the VPS, of the target output layer set, is specified as follows:
If some external means, not specified in this Specification, is available to set OutputLayerSetIdx, OutputLayerSetIdx is set by the external means.
Otherwise, if the decoding process is invoked in a bitstream conformance test as specified in subclause C.1, OutputLayerSetIdx is set as specified in subclause C.1.
Otherwise, OutputLayerSetIdx is set equal to 0.

lsetIdx = output_layer_set_idx_minus1[ OutputLayerSetIdx ] + 1;
for( i=0; i < numLayersInIdList[ lsetIdx ];i++) {

HighestTemporalIdList[ i ] = Min(HighestTid,

sub_layers_vps_max_minus1[ LayerIdxInVps[ TargetDecLayerIdList[ i ]]);
}

The sub-bitstream extraction process as specified in clause 10 is applied with the bitstream, HighestTid, and TargetDecLayerIdList as inputs, and the output is assigned to a bitstream referred to as BitstreamToDecode.

The decoding processes specified in the remainder of this subclause apply to each coded picture, referred to as the current picture and denoted by the variable CurrPic, in BitstreamToDecode.

Depending on the value of chroma_format_idc, the number of sample arrays of the current picture is as follows:
If chroma_format_idc is equal to 0, the current picture consists of 1 sample array SL.
Otherwise (chroma_format_idc is not equal to 0), the current picture consists of 3 sample arrays SL, SCb, SCr.

The decoding process for the current picture takes as inputs the syntax elements and upper-case variables from clause 7. When interpreting the semantics of each syntax element in each NAL unit, the term “the bitstream” (or part thereof, e.g. a CVS of the bitstream) refers to BitstreamToDecode (or part thereof).

### Listing (4)

The mathematical function Min is defined as

$$Min ( x , y ) = \{ \begin{matrix}x ; & x <= y \\ y ; & x > y\end{matrix}$$

In variant 3a of Listing (4), the temporal sub-layer identifier list HighestTemporalIdList specifies the list of values of the highest temporal identifier (TemporalId) present in the bitstream subset 120. This is derived as a minimum of the value between HighestTid and between sub_layers_vps_max_minus1[LayerIdxInVps[TargetDecLayerIdList[i]. Variant 3b of Listing (2) is more specific than variant 3a. For example, variant 3b defines how the OutputLayerSetIdx is calculated and then how 1SetIdx is calculated based on OutputLayerSetIdx and output_layer_set_idex_minus1. Variant 1b also uses numLayersInIdList[1SetIdx] in the for loop. Again HighestTemporalIdList is derived as a minimum of the value between HighestTid and between sub_layers_vps_max_minus1[LayerIdxInVps[TargetDecLayerIdList[i]].

The electronic device 102 may derive 408 the highest temporal identifier (TemporalId) values 124 per layer 122 during the derivation of bitstream conformance test (referred to as variant 2). An example of the language for JCTVC-L1003 for deriving 408 the highest temporal identifier (TemporalId) values 124 per layer 122 during the derivation of bitstream conformance test when using signaling from Table 1A or Table 1B is given below in Listing (5):

C.1 General

This annex specifies the hypothetical reference decoder (HRD) and its use to check bitstream and decoder conformance.

Two types of bitstreams or bitstream subsets are subject to HRD conformance checking for this Specification. The first type, called a Type I bitstream, is a NAL unit stream containing only the VCL NAL units and NAL units with nal_unit_type equal to FD_NUT (filler data NAL units) for all access units in the bitstream. The second type, called a Type II bitstream, contains, in addition to the VCL NAL units and filler data NAL units for all access units in the bitstream, at least one of the following:
additional non-VCL NAL units other than filler data NAL units,
all leading_zero_8 bits, zero_byte, start_code_prefix_one_3 bytes, and trailing_zero_8 bits syntax elements that form a byte stream from the NAL unit stream (as specified in Annex B).

Figure C-1 shows the types of bitstream conformance points checked by the HRD.

Figure C-1—Structure of byte streams and NAL unit streams for HRD conformance checks

The syntax elements of non-VCL NAL units (or their default values for some of the syntax elements), required for the HRD, are specified in the semantic subclauses of clause 7, Annexes D and E.

Two types of HRD parameter sets (NAL HRD parameters and VCL HRD parameters) are used. The HRD parameter sets are signalled through the hrd_parameters( ) syntax structure, which may be part of the SPS syntax structure or the VPS syntax structure. Multiple tests may be needed for checking the conformance of a bitstream, which is referred to as the bitstream under test. For each test, the following steps apply in the order listed:
1. An operation point under test, denoted as TargetOp, is selected. The layer identifier list OpLayerIdList of TargetOp consists of the list of nuh_layer_id values, in increasing order of nuh_layer_id values, present in the bitstream subset associated with TargetOp, which is a subset of the nuh_layer_id values present in the bitstream under test. The OpTid of TargetOp is equal to the highest TemporalId present in the bitstream subset associated with TargetOp.
2. TargetDecLayerIdList is set equal to OpLayerIdList of TargetOp, HighestTid is set equal to OpTid of TargetOp, and the sub-bitstream extraction process as specified in clause 10 is invoked with the bitstream under test, HighestTid, and TargetDecLayerIdList as inputs, and the output is assigned to BitstreamToDecode.
3. HighestTemporalIdList consists of list of values of highest TemporalId present in the bitstream subset associated with TargetOp in order for each of the layer in the TargetDecLayerIdList.
The HighestTemporalIdList could be derived as follows

for( i=0; i < number of layers in TargetDecLayerIdList;i++) {

HighestTemporalIdList[ i ] = Min(HighestTid,

sub_layers_vps_max_minus1[ LayerIdxInVps[ TargetDecLayerIdList[ i ] ]);
}

4. The hrd_parameters( ) syntax structure and the sub_layer_hrd_parameters( ) syntax structure applicable to TargetOp are selected. If TargetDecLayerIdList contains all nuh_layer_id values present in the bitstream under test, the hrd_parameters( ) syntax structure in the active SPS (or provided through an external means not specified in this Specification) is selected. Otherwise, the hrd_parameters( ) syntax structure in the active VPS (or provided through some external means not specified in this Specification) that applies to TargetOp is selected. Within the selected hrd_parameters( ) syntax structure, if BitstreamToDecode is a Type I bitstream, the sub_layer_hrd_parameters(HighestTid) syntax structure that immediately follows the condition “if(vcl_hrd_parameters_present_flag)” is selected and the variable NalHrdModeFlag is set equal to 0; otherwise (BitstreamToDecode is a Type II bitstream), the sub_layer_hrd_parameters(HighestTid) syntax structure that immediately follows either the condition “if(vcl_hrd_parameters_present_flag)” (in this case the variable NalHrdModeFlag is set equal to 0) or the condition “if(nal_hrd_parameters_present_flag)” (in this case the variable NalHrdModeFlag is set equal to 1) is selected. When BitstreamToDecode is a Type II bitstream and NalHrdModeFlag is equal to 0, all non-VCL NAL units except filler data NAL units, and all leading_zero_8 bits, zero byte, start_code_prefix_one_3 bytes, and trailing_zero_8 bits syntax elements that form a byte stream from the NAL unit stream (as specified in Annex B), when present, are discarded from BitstreamToDecode, and the remaining bitstream is assigned to BitstreamToDecode.

### Listing (5)

For Listing (2), Listing (3), Listing (4) and Listing (5), the marking process for sub-layer non-reference pictures not needed for inter-layer prediction specified in sub-clause F.8.1.2.1 may be invoked when the temporal identifier (TemporalId) is equal to HighestTemporalIdList[nuh_layer_id] during the decoding process for ending the decoding of a coded picture with nuh_layer_id greater than zero as specified in F.8.1.2. An example of the language for JCTVC-N1008 for invoking the marking process is given below in Listing (6):

F.8 Decoding process

F.8.1 General decoding process

The specifications in subclause 8.1 apply with following additions. When the current picture has nuh_layer_id greater than 0, the following applies.
Depending on the value of separate_colour_plane_flag, the decoding process is structured as follows:
   If separate_colour_plane_flag is equal to 0, the following decoding process is invoked a single time with the current picture being the output.
   Otherwise (separate_colour_plane_flag is equal to 1), the following decoding process is invoked three times. Inputs to the decoding process are all NAL units of the coded picture with identical value of colour_plane_id. The decoding process of NAL units with a particular value of colour_plane_{—id} is specified as if only a CVS with monochrome colour format with that particular value of colour_plane_id would be present in the bitstream. The output of each of the three decoding processes is assigned to one of the 3 sample arrays of the current picture, with the NAL units with colour_plane_id equal to 0, 1 and 2 being assigned to S_{L}, S_{Cb}, and S_{Cr}, respectively.
NOTE—The variable ChromaArrayType is derived as equal to 0 when separate_colour_plane_flag is equal to 1 and chroma_format_idc is equal to 3. In the decoding process, the value of this variable is evaluated resulting in operations identical to that of monochrome pictures (when chroma_format_idc is equal to 0).
The decoding process operates as follows for the current picture CurrPic.
   For the decoding of the slice segment header of the first slice, in decoding order, of the current picture, the decoding process for starting the decoding of a coded picture with nuh_layer_id greater than 0 specified in subclause F.8.1.1 is invoked.
   If ViewScalExtLayerFlag[nuh_layer_id ] is equal to 1, the decoding process for a coded picture with nuh_layer_id greater than 0 specified in subclause G.8.1 is invoked.
   Otherwise, when DependencyId[nuh_layer_kid] is greater than 0, the decoding process for a coded picture with nuh_layer_id greater than 0 specified in subclause H.8.1.1 is invoked.
   After all slices of the current picture have been decoded, the decoding process for ending the decoding of a coded picture with nuh_layer_id greater than 0 specified in subclause F.8.1.2 is invoked.

F.8.1.1 Decoding process for starting the decoding of a coded picture with nuh_layer_id greater than 0

Each picture referred to in this subclause is a complete coded picture.

The decoding process operates as follows for the current picture CurrPic:
1. The decoding of NAL units is specified in subclause 4.
2. The processes in subclause F.8.3 specify the following decoding processes using syntax elements in the slice segment layer and above:
   Variables and functions relating to picture order count are derived in subclause F.8.3.1. This needs to be invoked only for the first slice segment of a picture. It is a requirement of bitstream conformance that PicOrderCntVal shall remain unchanged within an access unit.
   The decoding process for RPS in subclause F.8.3.2 is invoked, wherein only reference pictures with a nuh_layer_id equal to that of CurrPic may be marked as “unused for reference” or “used for long-term reference” and any picture with a different value of nuh_layer_id is not marked. This needs to be invoked only for the first slice segment of a picture.
   When FirstPiclnLayerDecodedFlag[nuh_layer_id ] is equal to 0, the decoding process for generating unavailable reference pictures specified in subclause F.8.1.3 is invoked, which needs to be invoked only for the first slice segment of a picture.

F.8.1.2 Decoding process for ending the decoding of a coded picture with nuh_layer_id greater than 0

PicOutputFlag is set as follows:
If the current picture is a RASL picture and NoRaslOutputFlag of the associated IRAP picture is equal to 1, PicOutputFlag is set equal to 0.
Otherwise, if LayerInitialisedFlag[nuh_layer_id ] is equal to 0, PicOutputFlag is set equal to 0.
Otherwise, PicOutputFlag is set equal to pic_output_flag.

The following applies:
If discardable_flag is equal to 1, the decoded picture is marked as “unused for reference”.
Otherwise, the decoded picture is marked as “used for short-term reference”.

When TemporalId is equal to HighestTemporalIdList[i] where nuh_layer_id of the current layer is equal to TargetDecLayerIdList[i], the marking process for sub-layer non-reference pictures not needed for inter-layer prediction specified in subclause F.8.1.2.1 is invoked with latestDecLayerId equal to nuh_layer_id as input.

FirstPiclnLayerDecodedFlag[nuh_layer_id ] is set equal to 1.

In a variant embodiment:

When TemporalId is equal to Min(HighestTid, sps_max_sub_layers_minus1) where sps_max_sub_layers_minus1 corresponds to the value for the active SPS for the current layer, the marking process for sub-layer non-reference pictures not needed for inter-layer prediction specified in subclause F.8.1.2.1 is invoked with latestDecLayerId equal to nuh_layer_id as input.

FirstPicInLayerDecodedFlag[nuh_layer_id] is set equal to 1.

F.8.1.2.1 Marking process for sub-layer non-reference pictures not needed for inter-layer prediction

Input to this process is:
a nuh_layer_id value latestDecLayerId

Output of this process is:
potentially updated marking as “unused for reference” for some decoded pictures
NOTE—This process marks pictures that are not needed for inter or inter-layer prediction as “unused for reference”. When TemporalId is less than HighestTemporalIdList[i] where nuh_layer_id of the current layer is equal to TargetDecLayerIdList[i], the current picture may be used for reference in inter prediction and this process is not invoked.
In a variant embodiment:
NOTE—This process marks pictures that are not needed for inter or inter-layer prediction as “unused for reference”. When TemporalId is less than Min(HighestTid, sps_max_sublayers_minus1) where sps_max_sub_layers_minus1 corresponds to the value for the active SPS for the current layer, the current picture may be used for reference in inter prediction and this process is not invoked.

The variables numTargetDecLayers, and latestDecIdx are derived as follows:
numTargetDecLayers is set equal to the number of entries in TargetDecLayerIdList.
latestDecIdx is set equal to the value of i for which TargetDecLayerIdList[i] is equal to latestDecLayerId.

For i in the range of 0 to latestDecIdx, inclusive, the following applies for marking of pictures as “unused for reference”:
Let currPic be the picture in the current access unit with nuh_layer_id equal to TargetDecLayerIdList[i].
When currPic is marked as “used for reference” and is a sub-layer non-reference picture, the following applies:
   The variable currTid is set equal to the value of TemporalId of currPic.
   The variable remainingInterLayerReferencesFlag is derived as specified in the following:

```
  remainingInterLayerReferencesFlag = 0
  if ( currTid <=
( max_tid_il_ref_pics_plus1[ LayerIdxInVps
[ TargetDecLayerIdList[ i ] ] ] −1 ) )
    for( j = latestDecIdx + 1; j < numTargetDecLayers; j++ )
      for( k = 0; k < NumDirectRefLayers[TargetDecLayerIdList
      [ j ] ]; k++ )
        if( TargetDecLayerIdList[ i ] = =
RefLayerId[ TargetDecLayerIdList[ j ] ][ k ] )
        remainingInterLayerReferencesFlag = 1
```

When remainingInterLayerReferenceFlag is equal to 0, currPic is marked as “unused for reference”.

### Listing (6)

In another embodiment the signaled information sub_layers_vps_max_minus1[i] may be used to create a few additional variants, similar to Listing (2) and Listing (3), which use the signaled information regarding the maximum number of temporal sub-layers for a layer to derive the values of highest TemporalId for each layer. An example of the language for JCTVC-P1008 for deriving 406 the highest temporal identifier (TemporalId) values 124 per layer 122 when using the signaling from Table 1A or Table 1B is given below in Listing (7).

The general decoding process may receive an input to the process in the form of a bitstream. The output of this process is a list of decoded pictures.

The variable TargetOutputLayerSetIdx, which specifies the index to the list of the output layer sets specified by the VPS, of the target output layer set, is specified as follows:

If some external means, not specified in this Specification, is available to set TargetOutputLayerSetIdx, TargetOutputLayerSetIdx is set by the external means.

Otherwise, if the decoding process is invoked in a bitstream conformance test as specified in subclause C.1, TargetOutputLayerSetIdx is set as specified in subclause C.1.

Otherwise, TargetOutputLayerSetIdx is set equal to 0.

The variable TargetDecLayerSetIdx, the layer identifier list TargetOptLayerIdList, which specifies the list of nuh_layer_id values, in increasing order of nuh_layer_id values, of the pictures to be output, and the layer identifier list TargetDecLayerIdList, which specifies the list of nuh_layer_id values, in increasing order of nuh_layer_id values, of the NAL units to be decoded, are specified as follows:

TargetDecLayerSetIdx =
LayerSetIdxForOutputLayerSet[ TargetOutputLayerSetIdx ]
lsIdx = TargetDecLayerSetIdx
for( k = 0, j = 0; j < NumLayersInIdList[ lsIdx ]; j++ ) {

TargetDecLayerIdList[ j ] = LayerSetLayerIdList[ lsIdx ][ j ]
if( OutputLayerFlag[ TargetOutputLayerSetIdx ][ j ] )

TargetOptLayerIdList[ k++ ] = LayerSetLayerIdList[ lsIdx ][ j ]

}

The variable HighestTid, which identifies the highest temporal sub-layer to be decoded, is specified as follows:
If some external means, not specified in this Specification, is available to set HighestTid, HighestTid is set by the external means.
Otherwise, if the decoding process is invoked in a bitstream conformance test as specified in subclause C.1, HighestTid is set as specified in subclause C.1.
Otherwise, HighestTid is set equal to sps_max_sub_layers_minus1.

HighestTemporalIdList, which specifies the list of values of highest TemporalId for the layers in the layer identifier list TargetDecLayerIdList, is specified as follows:

TargetDecLayerSetIdx =
LayerSetIdxForOutputLayerSet[ TargetOutputLayerSetIdx ]
for( i = 0; i < NumLayersInIdList[ TargetDecLayerSetIdx ]; i++ ) {

iLstidx= LayerIdxInVPS[ TargetDecLayerIdList[ i ] ]
HighestTemporalIdList[ i ] =Min( HighestTid,

sub_layers_vps_max_minus1[ iLstidx ] );

}

In another embodiment the variable temporal sub-layer list HighestTemporalIdList which specifies the list of TemporalId values to be decoded for the layer identifier list TargetDecLayerIdList is specified as follows:

for( j = 0; j < NumLayersInIdList[ TargetDecLayerSetIdx ]; j++ ) {

jMidx= LayerIndxInVPS[TargetDecLayerIdList[ j ]]
HighestTemporalIdList [ j ]=Min(HighestTid,

sub_layers_vps_max_minus1[ jMidx ]);

if(!AltOutputLayerFlag[ TargetOutputLayerSetIdx ]) {

for( k = j+1; k < NumLayersInIdList[ TargetDecLayerSetIdx ];
k++ ){

kMidx = LayerIndxInVPS[ TargetDecLayerIdList[ k ] ]
HighestTemporalIdList [ j ]=Min( HighestTemporalIdList
[ j ],

(max_tid_il_ref_pic_plus1[ jMidx ][ kMidx ]−1) );

}

}

}

In another embodiment:

TargetDecLayerSetIdx =
LayerSetIdxForOutputLayerSet[ TargetOutputLayerSetIdx ]

lsIdx = TargetDecLayerSetIdx
for( k = 0, j = 0; j < NumLayersInIdList[ lsIdx ]; j++ ) {

TargetDecLayerIdList[ j ] = LayerSetLayerIdList[ lsIdx ][ j ]
if( OutputLayerFlag[ TargetOutputLayerSetIdx ][ j ] )

TargetOptLayerIdList[ k++ ] = LayerSetLayerIdList[ lsIdx ][ j ]

iLstIdx= LayerIdxInVPS[ TargetDecLayerIdList[ j ] ]

HighestTemporalIdList[ i ]

=Min( HighestTid, sub_layers_vps_max_minus1[ iLstIdx ] );

The sub-bitstream extraction process as specified in clause 10 is applied with the bitstream, HighestTid, and TargetDecLayerIdList as inputs, and the output is assigned to a bitstream referred to as BitstreamToDecode.

The decoding processes specified in the remainder of this subclause apply to each coded picture, referred to as the current picture and denoted by the variable CurrPic, in BitstreamToDecode.

Depending on the value of chroma_format_idc, the number of sample arrays of the current picture is as follows:
If chroma_format_idc is equal to 0, the current picture consists of 1 sample array S_{L}.
Otherwise (chroma_format_idc is not equal to 0), the current picture consists of 3 sample arrays S_{L}, S_{Cb}, S_{Cr}.

The decoding process for the current picture takes as inputs the syntax elements and upper-case variables from clause 7. When interpreting the semantics of each syntax element in each NAL unit, the term “the bitstream” (or part thereof, e.g. a CVS of the bitstream) refers to BitstreamToDecode (or part thereof).

When the current picture is an IRAP picture, the variable HandleCraAsBlaFlag is derived as specified in the following:
If some external means not specified in this Specification is available to set the variable HandleCraAsBlaFlag to a value for the current picture, the variable HandleCraAsBlaFlag is set equal to the value provided by the external means.
Otherwise, the variable HandleCraAsBlaFlag is set equal to 0.

When the current picture is an IRAP picture and has nuh_layer_id equal to 0, the following applies:
The variable NoClrasOutputFlag is specified as follows:
   If the current picture is the first picture in the bitstream, NoClrasOutputFlag is set equal to 1.
   Otherwise, if the current picture is a BLA picture or a CRA picture with HandleCraAsBlaFlag equal to 1, NoClrasOutputFlag is set equal to 1.
   Otherwise, if the current picture is an IDR picture with cross_layer_bla_flag is equal to 1, NoClrasOutputFlag is set equal to 1.
   Otherwise, if some external means, not specified in this Specification, is available to set NoClrasOutputFlag, NoClrasOutputFlag is set by the external means.
   Otherwise, NoClrasOutputFlag is set equal to 0.
When NoClrasOutputFlag is equal to 1, the variable LayerInitializedFlag[i] is set equal to 0 for all values of i from 0 to vps_max_layer_id, inclusive, and the variable FirstPiclnLayerDecodedFlag[i] is set equal to 0 for all values of i from 0 to vps_max_layer_id, inclusive.

The decoding process is specified such that all decoders will produce numerically identical cropped decoded pictures. Any decoding process that produces identical cropped decoded pictures to those produced by the process described herein (with the correct output order or output timing, as specified) conforms to the decoding process requirements of this Specification.

### Listing (7)

The electronic device 102 may derive 408 the highest temporal identifier (TemporalId) values 124 per layer 122 during the derivation of bitstream conformance test (referred to as variant 2). An example of the language for JCTVC-P1008 for deriving 408 the highest temporal identifier (TemporalId) values 124 per layer 122 during the derivation of bitstream conformance test when using signaling from Table 1A or Table 1B is given below in Listing (8):

C.1 General

This annex specifies the hypothetical reference decoder (HRD) and its use to check bitstream and decoder conformance.

Two types of bitstreams or bitstream subsets are subject to HRD conformance checking for this Specification. The first type, called a Type I bitstream, is a NAL unit stream containing only the VCL NAL units and NAL units with nal_unit_type equal to FD_NUT (filler data NAL units) for all access units in the bitstream. The second type, called a Type II bitstream, contains, in addition to the VCL NAL units and filler data NAL units for all access units in the bitstream, at least one of the following:
additional non-VCL NAL units other than filler data NAL units,
all leading_zero_8 bits, zero_byte, start_code_prefix_one_3 bytes, and trailing_zero_8 bits syntax elements that form a byte stream from the NAL unit stream (as specified in Annex B).

Figure C-1 shows the types of bitstream conformance points checked by the HRD.

The syntax elements of non-VCL NAL units (or their default values for some of the syntax elements), required for the HRD, are specified in the semantic subclauses of clause 7, Annexes D and E.

Two types of HRD parameter sets (NAL HRD parameters and VCL HRD parameters) are used. The HRD parameter sets are signalled through the hrd_parameters( ) syntax structure, which may be part of the SPS syntax structure or the VPS syntax structure. Multiple tests may be needed for checking the conformance of a bitstream, which is referred to as the bitstream under test. For each test, the following steps apply in the order listed:
(1) An operation point under test, denoted as TargetOp, is selected by selecting a target output layer set identified by TargetOutputLayerSetIdx and selecting a target highest TemporalId value HighestTid. The value of TargetOutputLayerSetIdx shall be in the range of 0 to NumOutputLayerSets—1, inclusive. The value of HighestTid shall be in the range of 0 to MaxSubLayersInLayerSetMinus1 [TargetoutputLayerSetIdx], inclusive. The variables TargetDecLayerSetIdx, TargetOptLayerIdList, and TargetDecLayerIdList are then derived as specified by Equation 8-1. The operation point under test has OptLayerIdList equal to TargetOptLayerIdList, OpLayerIdList equal to TargetDecLayerIdList, and OpTid equal to HighestTid.
(2) The sub-bitstream extraction process as specified in clause 10 is invoked with the bitstream under test, HighestTid, and TargetDecLayerIdList as inputs, and the output is assigned to BitstreamToDecode.
(3) HighestTemporalIdList, which specifies the list of values of highest TemporalId for the layers in the layer identifier list TargetDecLayerIdList, is derived as specified by Equation 8-2.
In another embodiment the HighestTemporalIdList, which specifies the list of values of highest TemporalId for the layers in the layer identifier list TargetDecLayerIdList, is derived as follows:

for( i = 0; i < NumLayersInIdList[ TargetDecLayerSetIdx ]; i++ ) {

iLstIdx= LayerIdxInVPS[ TargetDecLayerIdList[ i ] ]
HighestTemporalIdList[ i ] =Min( HighestTid,

```
  sub_layers_vps_max_minus1[ iLstIdx] );
  }
```

(4) When both the vps_vui_bsp_hrd_parameters( ) syntax structure is present in the active VPS and
num_bitstream_partitions[TargetDecLayerSetIdx] is greater than 1 or both a bitstream partition HRD parameters SEI message is present and the SEI message contains syntax element
num_sei_bitstreampartitions_minus1[TargetDecLayerSetIdx] greater than 0, either the bitstream-specific CPB operation or the bitstream-partition-specific CPB operation is selected for a conformance test, and both CPB operations shall be tested for checking the conformance of a bitstream. When the bitstream-specific CPB operation is tested, the subsequent steps apply for the bitstream under test. When the bitstream-partition-specific CPB operation is tested, the subsequent steps apply to each bitstream partition of the bitstream under test, referred to as the bitstream partition under test. When the bitstream-partition-specific CPB operation is tested and the input to the HRD is a bitstream, the bitstream partitions are derived with the demultiplexing process for deriving a bitstream partition in subclause C.6.

### Listing (8)

For Listing (9), the marking process for sub-layer non-reference pictures not needed for inter-layer prediction specified in sub-clause F.8.1.4.1 may be invoked when the temporal identifier (TemporalId) is equal to HighestTemporalIdList[nuh_layer_id] during the decoding process for ending the decoding of a coded picture with nuh_layer_id greater than zero as specified in F.8.1.4. In another embodiment When temporal identifier (TemporalId) is greater than or equal to HighestTemporalIdList[i] for any layer i where nuh_layer_id of the layer is equal to TargetDecLayerIdList[i], the marking process for sub-layer non-reference pictures not needed for inter-layer prediction specified in subclause F.8.1.4.1 is invoked with latestDecLayerId equal to nuh_layer_id as input. An example of the language for JCTVC-P1008 for invoking the marking process is given below in Listing (9):

The specifications in subclause 8.1 apply with following changes:
Replace the references to clause 7, and subclause 8.1.1 with subclauses F.7, and F.8.1.1, respectively.
At the end of the subclause, add the following sentence:
When the current picture has nuh_layer_id greater than 0, the decoding process for a coded picture with nuh_layer_id greater than 0 as specified in subclause 0 is invoked.

The specifications in subclause 8.1.1 apply with the following changes:
Replace the references to subclauses 8.2, 8.3, 8.3.1, 8.3.2, 8.3.3, 8.3.4, 8.4, 8.5, 8.6, and 8.7 with subclauses F.8.2, F.8.3, F.8.3.1, F.8.3.2, F.8.3.3, F.8.3.4, F.8.4, F.8.5, F.8.6, and F.8.7, respectively.
At the end of the subclause, add item 5 as follows:
   5. When FirstPiclnLayerDecodedFlag[0] is equal to 0, FirstPicInLayerDecodedFlag[0] is set equal to 1.

The decoding process operates as follows for the current picture CurrPic.
For the decoding of the slice segment header of the first slice, in decoding order, of the current picture, the decoding process for starting the decoding of a coded picture with nuh_layer_id greater than 0 specified in subclause F.8.1.3 is invoked.
If ViewScalExtLayerFlag[nuh_layer_id ] is equal to 1, the decoding process for a coded picture with nuh_layer_id greater than 0 specified in subclause G.8.1.1 is invoked.
Otherwise, when DependencyId[nuh_layer_id] is greater than 0, the decoding process for a coded picture with nuh_layer_id greater than 0 specified in subclause H.8.1.1 is invoked.
After all slices of the current picture have been decoded, the decoding process for ending the decoding of a coded picture with nuh_layer_id greater than 0 specified in subclause F.8.1.4 is invoked.

F.8.1.3 Decoding process for starting the decoding of a coded picture with nuh_layer_id greater than 0 Each picture referred to in this subclause is a complete coded picture. The decoding process operates as follows for the current picture CurrPic:
1. The decoding of NAL units is specified in subclause F.8.2.
2. The processes in subclause F.8.3 specify the following decoding processes using syntax elements in the slice segment layer and above:
   Variables and functions relating to picture order count are derived in subclause F.8.3.1. This needs to be invoked only for the first slice segment of a picture. It is a requirement of bitstream conformance that PicOrderCntVal shall remain unchanged within an access unit.
   The decoding process for RPS in subclause F.8.3.2 is invoked, wherein only reference pictures with nuh_layer_id equal to that of CurrPic may be marked as “unused for reference” or “used for long-term reference” and any picture with a different value of nuh_layer_id is not marked. This needs to be invoked only for the first slice segment of a picture.
   When FirstPiclnLayerDecodedFlag[nuh_layer_id] is equal to 0, the decoding process for generating unavailable reference pictures specified in subclause F.8.1.5 is invoked, which needs to be invoked only for the first slice segment of a picture.
   When FirstPicInLayerDecodedFlag[nuh_layer_id] is not equal to 0 and the current picture is an IRAP picture with NoRaslOutputFlag equal to 1, the decoding process for generating unavailable reference pictures specified in subclause F.8.3.3 is invoked, which needs to be invoked only for the first slice segment of a picture.

F.8.1.4 Decoding process for ending the decoding of a coded picture with nuh_layer_id greater than 0

PicOutputFlag is set as follows:
If LayerInitializedFlag[nuh_layer_id] is equal to 0, PicOutputFlag is set equal to 0.
Otherwise, if the current picture is a RASL picture and NoRaslOutputFlag of the associated IRAP picture is equal to 1, PicOutputFlag is set equal to 0.
Otherwise, PicOutputFlag is set equal to pic_output_flag.

The following applies:
If discardable_flag is equal to 1, the decoded picture is marked as “unused for reference”.
Otherwise, the decoded picture is marked as “used for short-term reference”.

When TemporalId is greater than or equal to HighestTemporalIdList[i] for any layer i where nuh_layer_id of the layer is equal to TargetDecLayerIdList[i], the marking process for sub-layer non-reference pictures not needed for inter-layer prediction specified in subclause F.8.1.4.1 is invoked with latestDecLayerId equal to nuh_layer_id as input.

In another embodiment when TemporalId is equal to HighestTemporalIdList[i] where nuh_layer_id of the current layer is equal to TargetDecLayerIdList[i], the marking process for sub-layer non-reference pictures not needed for inter-layer prediction specified in subclause F.8.1.4.1 is invoked with latestDecLayerId equal to nuh_layer_id as input.

In another embodiment when TemporalId is equal to min(HighestTid, sps_max_sub_layers_minus1) where sps_max_sub_layers_minus1 corresponds to the value for the active SPS for the current layer, the marking process for sub-layer non-reference pictures not needed for inter-layer prediction specified in subclause F.8.1.4.1 is invoked with latestDecLayerId equal to nuh_layer_id as input.

When FirstPiclnLayerDecodedFlag[nuh_layer_id] is equal to 0, FirstPiclnLayerDecodedFlag[nuh_layer_id] is set equal to 1.

F.8.1.4.1 Marking process for sub-layer non-reference pictures not needed for inter-layer prediction

Input to this process is:
a nuh_layer_id value latestDecLayerId

Output of this process is:
potentially updated marking as “unused for reference” for some decoded pictures
This process marks pictures that are not needed for inter or inter-layer prediction as “unused for reference”. When TemporalId is less than HighestTemporalIdList[i] where nuh_layer_id of the current layer is equal to TargetDecLayerIdList[i], the current picture may be used for reference in inter prediction and this process is not invoked.

In another embodiment this process marks pictures that are not needed for inter or inter-layer prediction as “unused for reference”. When TemporalId is less than HighestTemporalIdList[i] where nuh_layer_id of the layer is equal to TargetDecLayerIdList[i], the current picture may be used for reference in inter prediction and this process is not invoked.

In another embodiment this process marks pictures that are not needed for inter or inter-layer prediction as “unused for reference”. When TemporalId is less than min(HighestTid, sps_max_sublayers_minus1), the current picture may be used for reference in inter prediction and this process is not invoked.

In another embodiment this process marks pictures that are not needed for inter or inter-layer prediction as “unused for reference”. When TemporalId is less than min(HighestTid, sps_max_sublayers_minus1) where sps_max_sublayers_minus1 corresponds to the value for the active SPS for the current layer, the current picture may be used for reference in inter prediction and this process is not invoked.

The variables numTargetDecLayers, and latestDecIdx are derived as follows:
numTargetDecLayers is set equal to the number of entries in TargetDecLayerIdList.
latestDecIdx is set equal to the value of i for which TargetDecLayerIdList[i] is equal to latestDecLayerId.

For i in the range of 0 to latestDecIdx, inclusive, the following applies for marking of pictures as “unused for reference”:
Let currPic be the picture in the current access unit with nuh_layer_id equal to TargetDecLayerIdList[i].
When currPic is marked as “used for reference” and is a sub-layer non-reference picture, the following applies:
   The variable currTid is set equal to the value of TemporalId of currPic.
   The variable remainingInterLayerReferencesFlag is derived as specified in the following:

remainingInterLayerReferencesFlag = 0
iLidx = LayerIdxInVps[ TargetDecLayerIdList[ i ] ]

for( j = latestDecIdx + 1; j < numTargetDecLayers; j++ ) {

jLidx = LayerIdxInVps[ TargetDecLayerIdList[ j ] ]
if( currTid <= ( max_tid_il_ref_pics_plus1[ iLidx ][ jLidx ] −
1 ) )

for( k = 0;
k < NumDirectRefLayers[ TargetDecLayerIdList[ j ] ];

k++)

if( TargetDecLayerIdList[ i ] = =

RefLayerId[ TargetDecLayerIdList[ j ] ][ k ] )

remainingInterLayerReferencesFlag = 1

}

When remainingInterLayerReferenceFlag is equal to 0, currPic is marked as “unused for reference”.

### Listing (9)

In another variant embodiment the marking process for sub-layer non-reference pictures not needed for inter-layer prediction may be as shown in listing (10) below:

F.8.1.4.1 Marking process for sub-layer non-reference pictures not needed for inter-layer prediction

Input to this process is:
a nuh_layer_id value latestDecLayerId

Output of this process is:
potentially updated marking as “unused for reference” for some decoded pictures
This process marks pictures that are not needed for inter or inter-layer prediction as “unused for reference”. When TemporalId is less than HighestTemporalIdList[i] where nuh_layer_id of the layer is equal to TargetDecLayerIdList[i], the current picture may be used for reference in inter prediction and this process is not invoked.

The variables numTargetDecLayers, and latestDecIdx are derived as follows:
numTargetDecLayers is set equal to the number of entries in TargetDecLayerIdList.
latestDecIdx is set equal to the value of i for which TargetDecLayerIdList[i] is equal to latestDecLayerId.

For i in the range of 0 to latestDecIdx, inclusive, the following applies for marking of pictures as “unused for reference”:
Let currPic be the picture in the current access unit with nuh_layer_id equal to TargetDecLayerIdList[i].
When currPic is marked as “used for reference” and is a sub-layer non-reference picture and TemporalId is equal to HighestTemporalIdList[i] where nuh_layer_id of CurrPic is equal to TargetDecLayerIdList[i], the following applies:
   The variable currTid is set equal to the value of TemporalId of currPic.
   The variable remainingInterLayerReferencesFlag is derived as specified in the following:

remainingInterLayerReferencesFlag = 0
iLidx = LayerIdxInVps[ TargetDecLayerIdList[ i ] ]

for( j = latestDecIdx + 1; j < numTargetDecLayers; j++ ) {

jLidx = LayerIdxInVps[ TargetDecLayerIdList[ j ] ]
if( currTid <= ( max_tid_il_ref_pics_plus1[ iLidx ][ jLidx ] −
1 ) )

for( k = 0;
k < NumDirectRefLayers[ TargetDecLayerIdList[ j ] ];

k++)

if( TargetDecLayerIdList[ i ] = =

RefLayerId[ TargetDecLayerIdList[ j ] ][ k ] )

remainingInterLayerReferencesFlag = 1

}

When remainingInterLayerReferenceFlag is equal to 0, currPic is marked as “unused for reference”.

### Listing (10)

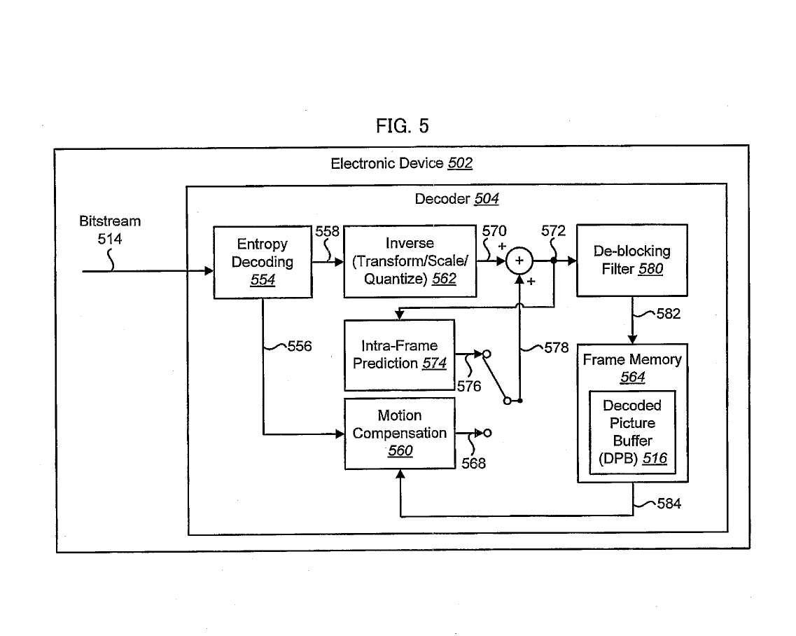

FIG. 5 is a block diagram illustrating one configuration of a decoder 504. The decoder 504 may be included in an electronic device 502. For example, the decoder 504 may be a high-efficiency video coding (HEVC) decoder. The decoder 504 and/or one or more of the elements illustrated as included in the decoder 504 may be implemented in hardware, software or a combination of both. The decoder 504 may receive a bitstream 514 (e.g., one or more encoded pictures included in the bitstream 514) for decoding. In some configurations, the received bitstream 514 may include received overhead information, such as a received slice header, received picture parameter set (PPS), received buffer description information, etc. The encoded pictures included in the bitstream 514 may include one or more encoded reference pictures and/or one or more other encoded pictures.

Received symbols (in the one or more encoded pictures included in the bitstream 514) may be entropy decoded by an entropy decoding module 554, thereby producing a motion information signal 556 and quantized, scaled and/or transformed coefficients 558.

The motion information signal 556 may be combined with a portion of a reference frame signal 584 from a frame memory 564 at a motion compensation module 560, which may produce an inter-frame prediction signal 568. The quantized, descaled and/or transformed coefficients 558 may be inverse quantized, scaled and inverse transformed by an inverse module 562, thereby producing a decoded residual signal 570. The decoded residual signal 570 may be added to a prediction signal 578 to produce a combined signal 572. The prediction signal 578 may be a signal selected from either the inter-frame prediction signal 568 or an intra-frame prediction signal 576 produced by an intra-frame prediction module 574. In some configurations, this signal selection may be based on (e.g., controlled by) the bitstream 514.

The intra-frame prediction signal 576 may be predicted from previously decoded information from the combined signal 572 (in the current frame, for example). The combined signal 572 may also be filtered by a de-blocking filter 580. The resulting filtered signal 582 may be written to frame memory 564. The resulting filtered signal 582 may include a decoded picture.

The frame memory 564 may include a decoded picture buffer (DPB) 516 as described herein. The decoded picture buffer (DPB) 516 may be capable of hybrid decoded picture buffer (DPB) 116 operations. The decoded picture buffer (DPB) 516 may include one or more decoded pictures that may be maintained as short or long term reference frames. The frame memory 564 may also include overhead information corresponding to the decoded pictures. For example, the frame memory 564 may include slice headers, video parameter set (VPS) information, sequence parameter set (SPS) information, picture parameter set (PPS) information, cycle parameters, buffer description information, etc. One or more of these pieces of information may be signaled from an encoder (e.g., encoder 108, overhead signaling module 112).

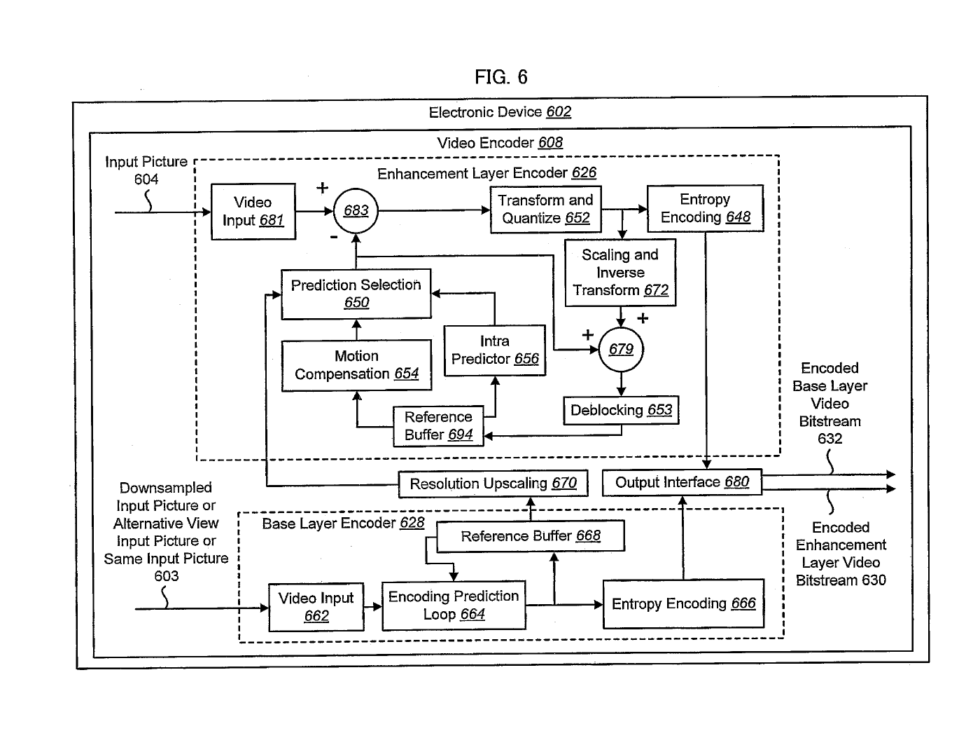

FIG. 6 is a block diagram illustrating one configuration of a video encoder 608 on an electronic device 602. The video encoder 608 of FIG. 6 may be one configuration of the encoder 108 of FIG. 1. The video encoder 608 may include an enhancement layer encoder 626, a base layer encoder 628, a resolution upscaling block 670 and an output interface 680.

The enhancement layer encoder 626 may include a video input 681 that receives an input picture 604. The output of the video input 681 may be provided to an adder/subtractor 683 that receives an output of a prediction selection 650. The output of the adder/subtractor 683 may be provided to a transform and quantize block 652. The output of the transform and quantize block 652 may be provided to an entropy encoding block 648 and a scaling and inverse transform block 672. After entropy encoding 648 is performed, the output of the entropy encoding block 648 may be provided to the output interface 680. The output interface 680 may output both the encoded base layer video bitstream 632 and the encoded enhancement layer video bitstream 630.

The output of the scaling and inverse transform block 672 may be provided to an adder 679. The adder 679 may also receive the output of the prediction selection 650. The output of the adder 679 may be provided to a deblocking block 653. The output of the deblocking block 653 may be provided to a reference buffer. An output of the reference buffer 694 may be provided to a motion compensation block 654. The output of the motion compensation block 654 may be provided to the prediction selection 650. An output of the reference buffer 694 may also be provided to an intra predictor 656. The output of the intra predictor 656 may be provided to the prediction selection 650. The prediction selection 650 may also receive an output of the resolution upscaling block 670.

The base layer encoder 628 may include a video input 662 that receives a downsampled input picture or an alternative view input picture or the same input picture 603 (i.e., the same as the input picture 604 received by the enhancement layer encoder 626). The output of the video input 662 may be provided to an encoding prediction loop 664. Entropy encoding 666 may be provided on the output of the encoding prediction loop 664. The output of the encoding prediction loop 664 may also be provided to a reference buffer 668. The reference buffer 668 may provide feedback to the encoding prediction loop 664. The output of the reference buffer 668 may also be provided to the resolution upscaling block 670. Once entropy encoding 666 has been performed, the output may be provided to the output interface 680.

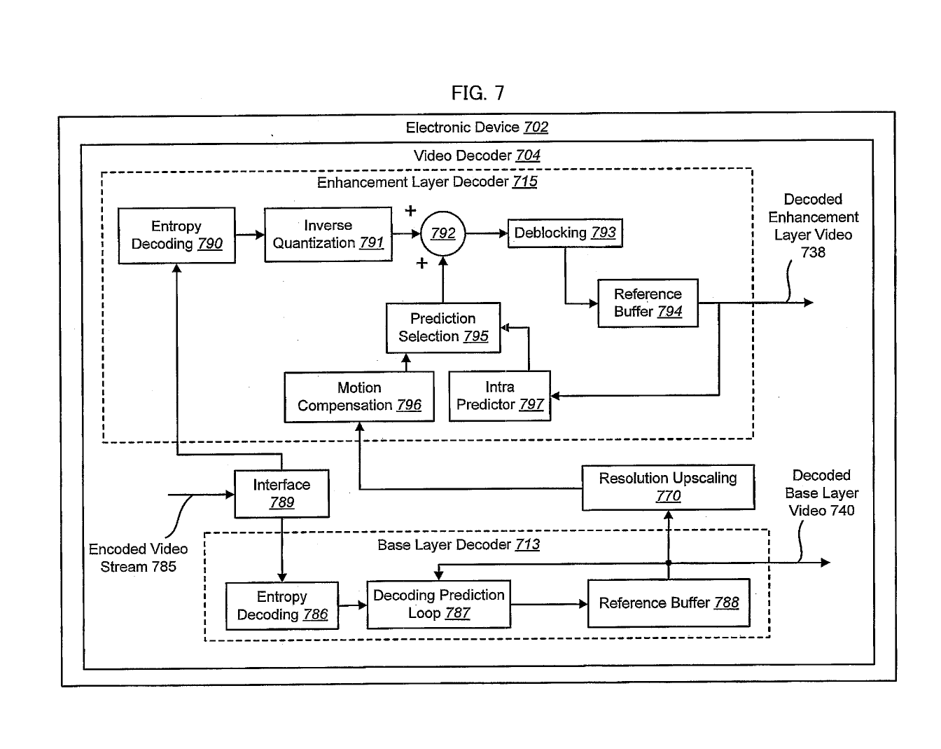

FIG. 7 is a block diagram illustrating one configuration of a video decoder 704 on an electronic device 702. The video decoder 704 of FIG. 7 may be one configuration of the decoder 104 of FIG. 1. The video decoder 704 may include an enhancement layer decoder 715 and a base layer decoder 713. The video decoder 704 may also include an interface 789 and resolution upscaling 770.

The interface 789 may receive an encoded video stream 785. The encoded video stream 785 may include a base layer encoded video stream and an enhancement layer encoded video stream. The base layer encoded video stream and the enhancement layer encoded video stream may be sent separately or together. The interface 789 may provide some or all of the encoded video stream 785 to an entropy decoding block 786 in the base layer decoder 713. The output of the entropy decoding block 786 may be provided to a decoding prediction loop 787. The output of the decoding prediction loop 787 may be provided to a reference buffer 788. The reference buffer may provide feedback to the decoding prediction loop 787. The reference buffer 788 may also output the decoded base layer video 740.

The interface 789 may also provide some or all of the encoded video stream 785 to an entropy decoding block 790 in the enhancement layer decoder 715. The output of the entropy decoding block 790 may be provided to an inverse quantization block 791. The output of the inverse quantization block 791 may be provided to an adder 792. The adder 792 may add the output of the inverse quantization block 791 and the output of a prediction selection block 795. The output of the adder 792 may be provided to a de-blocking block 793. The output of the deblocking block 793 may be provided to a reference buffer 794. The reference buffer 794 may output the decoded enhancement layer video 738.

The output of the reference buffer 794 may also be provided to an intra predictor 797. The enhancement layer decoder 715 may include motion compensation 796. The motion compensation 796 may be performed after the resolution upscaling 770. The prediction selection block 795 may receive the output of the intra predictor 797 and the output of the motion compensation 796.

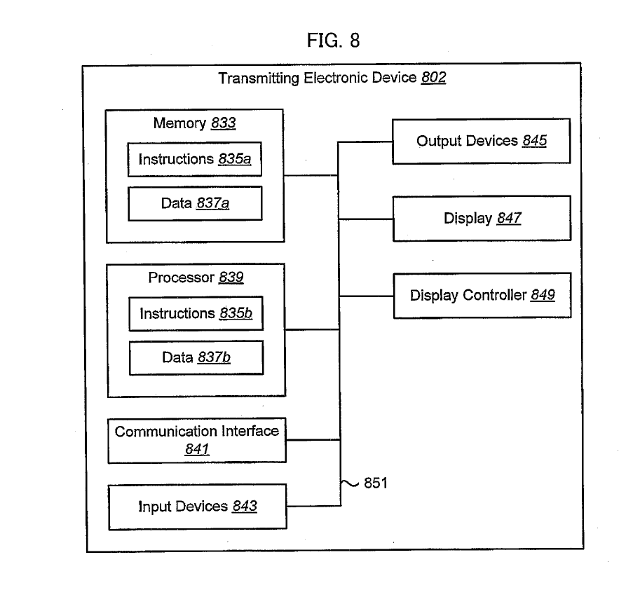

FIG. 8 illustrates various components that may be utilized in a transmitting electronic device 802. One or more of the electronic devices 102 described herein may be implemented in accordance with the transmitting electronic device 802 illustrated in FIG. 8.

The transmitting electronic device 802 includes a processor 839 that controls operation of the transmitting electronic device 802. The processor 839 may also be referred to as a central processing unit (CPU). Memory 833, which may include both read-only memory (ROM), random access memory (RAM) or any type of device that may store information, provides instructions 835a (e.g., executable instructions) and data 837a to the processor 839. A portion of the memory 833 may also include non-volatile random access memory (NVRAM). The memory 833 may be in electronic communication with the processor 839.

Instructions 835b and data 837b may also reside in the processor 839. Instructions 835b and/or data 837b loaded into the processor 839 may also include instructions 835a and/or data 837a from memory 833 that were loaded for execution or processing by the processor 839. The instructions 835b may be executed by the processor 839 to implement one or more of the methods disclosed herein.

The transmitting electronic device 802 may include one or more communication interfaces 841 for communicating with other electronic devices (e.g., receiving electronic device). The communication interfaces 841 may be based on wired communication technology, wireless communication technology, or both. Examples of a communication interface 841 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, a wireless transceiver in accordance with 3^{rd} Generation Partnership Project (3GPP) specifications and so forth.

The transmitting electronic device 802 may include one or more output devices 845 and one or more input devices 843. Examples of output devices 845 include a speaker, printer, etc. One type of output device that may be included in a transmitting electronic device 802 is a display device 847. Display devices 847 used with configurations disclosed herein may utilize any suitable image projection technology, such as a cathode ray tube (CRT), liquid crystal display (LCD), light-emitting diode (LED), gas plasma, electroluminescence or the like. A display controller 849 may be provided for converting data stored in the memory 833 into text, graphics, and/or moving images (as appropriate) shown on the display 847. Examples of input devices 843 include a keyboard, mouse, microphone, remote control device, button, joystick, trackball, touchpad, touchscreen, lightpen, etc.

The various components of the transmitting electronic device 802 are coupled together by a bus system 851, which may include a power bus, a control signal bus and a status signal bus, in addition to a data bus. However, for the sake of clarity, the various buses are illustrated in FIG. 8 as the bus system 851. The transmitting electronic device 802, illustrated in FIG. 8, is a functional block diagram rather than a listing of specific components.

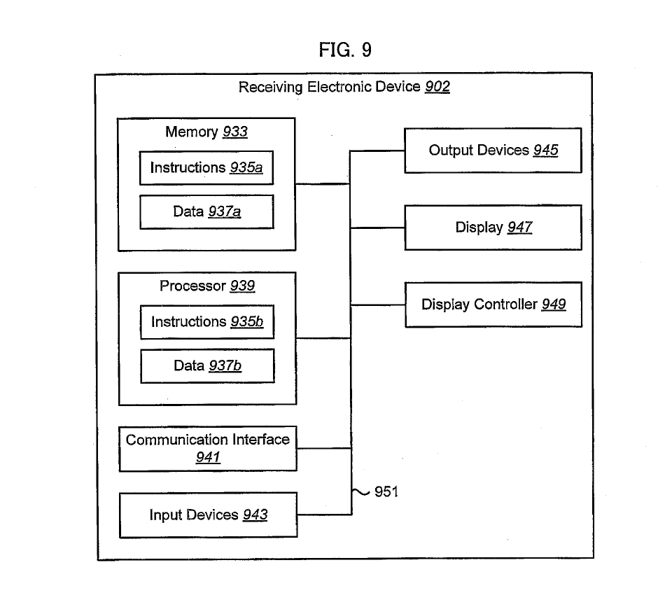

FIG. 9 is a block diagram illustrating various components that may be utilized in a receiving electronic device 902. One or more of the electronic devices 902 may be implemented in accordance with the receiving electronic device 902 illustrated in FIG. 9.

The receiving electronic device 902 includes a processor 939 that controls operation of the receiving electronic device 902. The processor 939 may also be referred to as a CPU. Memory 933, which may include both ROM, RAM or any type of device that may store information, provides instructions 935a (e.g., executable instructions) and data 937a to the processor 939. A portion of the memory 933 may also include NVRAM. The memory 933 may be in electronic communication with the processor 939.

Instructions 935b and data 937b may also reside in the processor 939. Instructions 935b and/or data 937b loaded into the processor 939 may also include instructions 935a and/or data 937a from memory 933 that were loaded for execution or processing by the processor 939. The instructions 935b may be executed by the processor 939 to implement one or more of the methods disclosed herein.

The receiving electronic device 902 may include one or more communication interfaces 941 for communicating with other electronic devices (e.g., a transmitting electronic device). The communication interfaces 941 may be based on wired communication technology, wireless communication technology, or both. Examples of a communication interface 941 include a serial port, a parallel port, a USB, an Ethernet adapter, an IEEE 1394 bus interface, a SCSI bus interface, an IR communication port, a Bluetooth wireless communication adapter, a wireless transceiver in accordance with 3GPP specifications and so forth.

The receiving electronic device 902 may include one or more output devices 945 and one or more input devices 943. Examples of output devices 945 include a speaker, printer, etc. One type of output device 945 that may be included in a receiving electronic device 902 is a display device 947. Display devices 947 used with configurations disclosed herein may utilize any suitable image projection technology, such as a CRT, LCD, LED, gas plasma, electroluminescence or the like. A display controller 949 may be provided for converting data stored in the memory 933 into text, graphics, and/or moving images (as appropriate) shown on the display 947. Examples of input devices 943 include a keyboard, mouse, microphone, remote control device, button, joystick, trackball, touchpad, touchscreen, lightpen, etc.

The various components of the receiving electronic device 902 are coupled together by a bus system 951, which may include a power bus, a control signal bus and a status signal bus, in addition to a data bus. However, for the sake of clarity, the various buses are illustrated in FIG. 9 as the bus system 951. The receiving electronic device 902 illustrated in FIG. 9 is a functional block diagram rather than a listing of specific components.

The term “computer-readable medium” refers to any available medium that can be accessed by a computer or a processor. The term “computer-readable medium, ” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray (registered trademark) disc where disks usually reproduce data magnetically, while discs reproduce data optically with lasers.

It should be noted that one or more of the methods described herein may be implemented in and/or performed using hardware. For example, one or more of the methods or approaches described herein may be implemented in and/or realized using a chipset, an ASIC, a LSI or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

1. A method for video coding, comprising:
signaling a flag indicating whether information indicating the maximum number of temporal sub-layers is present; and
signaling the information for each layer i by a video parameter set in a case that the value of the flag is equal to one; wherein
the information specifies, for each i in a range of 0 to the number of maximum layers minus one, the maximum number of the temporal sub-layers that may be present in a coded video sequence for a layer with num layer id equal to layer id in nuh[i].

2.-6. (canceled)

7. An electronic device configured for video coding, comprising:
a processor;
memory in electronic communication with the processor, wherein instructions stored in the memory are executable to:
signal a flag indicating whether information indicating the maximum number of temporal sub-layers is present; and
signal the information for each layer i by a video parameter set in a case that the value of the flag is equal to one; wherein
the information specifies, for each i in a range of 0 to the number of maximum layers minus one, the maximum number of the temporal sub-layers that may be present in a coded video sequence for a layer with num layer id equal to layer id in nuh[i].

8-18. (canceled)

19. An electronic device configured for video decoding, comprising:
a processor;
memory in electronic communication with the processor, wherein instructions stored in the memory are executable to:
receive a flag indicating whether information indicating the maximum number of temporal sub-layers is present; and
receive the information for each layer i by a video parameter set in a case that the value of the flag is equal to one; wherein
the information specifies, for each i in a range of 0 to the number of maximum layers minus one, the maximum number of the temporal sub-layers that may be present in a coded video sequence for a layer with num layer id equal to layer id in nuh[i].

20-36. (canceled)
